(19) United States
(12) Patent Application Publication
(10) Pub. No.: US 2018/0371251 A1
(43) Pub. Date: Dec. 27, 2018

(54) LATEXES CONTAINING POLYPHOSPHORIC ACID FOR ASPHALT MODIFICATION

(71) Applicant: BASF SE, Ludwigshafen (DE)

(72) Inventors: Kostas S. AVRAMIDIS, Charlotte, NC (US); William J. KIRK, York, SC (US)

(73) Assignee: BASF SE, Ludwigshafen (DE)

(21) Appl. No.: 16/064,570

(22) PCT Filed: Dec. 21, 2016
(86) PCT No.: PCT/US16/67970

§ 371 Date: Jun. 21, 2018

Related U.S. Application Data
(60) Provisional application No. 62/270,280, filed on Dec. 21, 2015.

(51) Int. Cl. C08L 95/00; C08K 3/32; C08K 3/30

(52) U.S. Cl. CPC C08L 95/005; C08K 3/32; C08L 11/02; C08K 2003/329; C08K 2003/3081; C08K 3/30

(57) ABSTRACT

Disclosed herein are latex compositions and asphalt formulations comprising the latex compositions. In some embodiments, the latex compositions include a styrene-butadiene copolymer and polyphosphoric acid represented by the formula, Hn+2PnO3n+1, wherein n is an integer from 2 to 30. The latex composition can be used to prepare polymer-modified asphalt emulsions and hot mix asphalt compositions. The asphalt formulations can be prepared by contacting asphalt with a latex composition as described herein and a sulfur curing agent. Methods of coating a surface comprising applying an asphalt formulation as described herein to the surface are also disclosed.

### CROSS-REFERENCE TO RELATED APPLICATIONS

This application claims the benefit of and priority to U.S. Patent Application No. 62/270,280 filed on Dec. 21, 2015, the disclosure of which is expressly incorporated herein by reference in its entirety.

### FIELD OF THE DISCLOSURE

This disclosure relates generally to asphalt formulations, and more particularly to asphalt formulations that include a latex containing polyphosphoric acid, and to methods of making and using the asphalt formulations.

### BACKGROUND OF THE DISCLOSURE

Various types of asphalt compositions and there methods of manufacture are known in the art. In particular, the properties of asphalt may be improved by the incorporation of a polymer or other additive. This improves adhesion, ductility, tensile strength, and cold temperature properties of the asphalt. However, the degree to which an additive improves an asphalt's properties depends on the compatibility of the additive and the asphalt; e.g., a polymer that does not separate in a mixture of asphalt and polymer during storage. Highly compatible or compatibilized additives are more effective in providing property improvements. There is a need for compatibilized asphalt additives for asphalt compositions. The compositions and methods described herein address these and other needs.

### SUMMARY OF THE DISCLOSURE

Disclosed herein are latex compositions (e.g., dispersions) comprising polyphosphoric acid and asphalt formulations comprising the latex compositions. Methods of making and using the compositions described herein are also disclosed.

The latex composition can be an aqueous latex dispersion comprising a polymer selected from styrene-butadiene copolymers, polychloroprene, styrene-butadiene-styrene block copolymers, ethylene vinyl acetate copolymers, styrene acrylic copolymers, pure acrylic polymers, vinyl acrylic copolymers, and combinations thereof. In some embodiments, the dispersion has a pH of 7 or less. In some embodiments, the dispersion can be cationic or anionic. In some embodiments, the latex dispersion includes a styrene-butadiene copolymer.

The polyphosphoric acid can include a compound represented by the formula, Hₙ₊₂PₙO₃ₙ₊₁, wherein n is an integer from 2 to 30. The polyphosphoric acid can be present in an amount of from 0.05 wt % to 15 wt %, based on the weight of the latex dispersion. In certain embodiments, the latex dispersion does not include an organic phosphorous-containing compound.

The latex dispersion can further include an additional acid. The additional acid can be selected from phosphoric acid, hydrochloric acid, sulfuric acid, citric acid, tartaric acid, and combinations thereof. In some embodiments, the latex dispersion can include phosphoric acid. The phosphoric acid can be present in an amount of from 0.3 wt % to 3 wt %, based on the weight of the latex dispersion. In some embodiments, the latex dispersion does not include an acid in addition to polyphosphoric acid.

In some embodiments, the latex dispersion can include a basic salt, such as aluminum sulfate. The aluminum sulfate can be present in an amount of from 0.01 wt % to 15 wt %, based on the weight of the latex dispersion.

In some embodiments, the latex dispersion can include a sulfur curing agent. The sulfur curing agent can include sulfur, sulfur halides, sulfur donors, or mixtures thereof.

As described herein, the latex dispersion can be used to prepare (polymer-modified) asphalt formulations. The asphalt formulations can be prepared by contacting asphalt with a latex dispersion as described herein. In some embodiments, the asphalt can be further contacted with a sulfur curing agent. In some embodiments, the sulfur curing agent can be present in an amount of from 0.01% to 0.6% by weight of the asphalt. The latex dispersion and the sulfur curing agent can be mixed with the asphalt simultaneously (e.g., the sulfur curing agent can be provided in the latex dispersion). In some embodiments, the asphalt can be further contacted with aluminum sulfate. For example, the aluminum sulfate can be provided in the latex dispersion. In some embodiments, the latex dispersion is cationic.

Asphalt emulsions are disclosed herein. The asphalt emulsion can include asphalt, a polymer as described herein, a cationic surfactant, polyphosphoric acid, a sulfur curing agent, and water. The asphalt emulsion can include asphalt in an amount of from 50 wt % to 95 wt %, based on the weight of the asphalt emulsion. The asphalt emulsion can include the polymer in an amount of from 0.05 wt % to 10 wt %, based on the weight of the asphalt emulsion. In some embodiments, the asphalt emulsion can include the polymer in an amount of from 0.5 wt % to 3 wt %, based on the weight of the asphalt emulsion. The asphalt emulsion can further comprise aluminum sulfate. The asphalt emulsion can further comprise an aggregate. In some embodiments, when the asphalt emulsion comprises an asphalt solids content of 65 wt %, based on the weight of the asphalt emulsion, the asphalt emulsion has a viscosity of from 100 to 2500 cp at 60° C. as determined using a Brookfield viscometer, spindle #3 at 20 rpm. In some embodiments, the asphalt emulsion has a softening point that is 5° C. or greater than the softening point of the same asphalt emulsion without polyphosphoric acid.

Hot mix asphalt compositions are also disclosed herein. The hot mix asphalt compositions can comprise asphalt and a polymer as described herein, polyphosphoric acid, and a sulfur curing agent, wherein the composition has a pH of 7 or less. The hot mix asphalt compositions can include asphalt in an amount of from 50 wt % to 99.9 wt %, based on the weight of the hot mix asphalt composition. The hot mix asphalt composition can include the polymer in an amount of from 0.05 wt % to 10 wt %, based on the weight of the hot mix asphalt composition. In some embodiments, the hot mix asphalt composition can include the polymer in an amount of from 0.5 wt % to 3 wt %, based on the weight of the hot mix asphalt composition. The hot mix asphalt composition can further comprise an aluminum sulfate. The hot mix asphalt composition can further comprise an aggregate. In some embodiments, when the hot mix asphalt composition comprises an asphalt solids content of 65 wt %, based on the weight of the hot mix asphalt composition, the hot mix asphalt composition has a viscosity of from 1000 to 3000 cp at 60° C. as determined using a Brookfield viscometer, spindle #3 at 20 rpm. In some embodiments, the hot mix asphalt composition has a softening point that is 5° C. or greater than the softening point of the same hot mix asphalt composition without polyphosphoric acid.

Methods of coating a surface comprising applying an asphalt emulsion or a hot-mix asphalt composition to the surface are also disclosed herein.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 is a bar graph showing the moisture loss and aggregate loss of a hydrochloric acid flipped styrene-butadiene polymer-modified asphalt emulsion (control) and a styrene-butadiene polymer-modified asphalt emulsion containing 0.5% polyphosphoric acid (Example 1).

FIG. 2 is a bar graph showing the moisture loss and aggregate loss of a hydrochloric acid flipped styrene-butadiene polymer-modified asphalt emulsion (control 2) and a phosphoric acid flipped styrene-butadiene polymer-modified asphalt emulsion containing polyphosphoric acid (Example 2).

FIG. 3 is a graph showing the particle size distribution of the styrene-butadiene polymer-modified asphalt emulsions exemplified in FIG. 2.

FIG. 4 is a bar graph showing the moisture loss and aggregate loss of a styrene-butadiene polymer-modified asphalt emulsion (control) and a polyphosphoric acid-flipped styrene-butadiene polymer-modified asphalt emulsion containing 25% KOH in an amount to adjust pH and aluminum sulfate (Example 4).

FIG. 5 is a graph showing the particle size distribution of the styrene-butadiene polymer-modified asphalt emulsions exemplified in FIG. 4.

FIG. 6 is a bar graph showing the moisture loss and aggregate loss of a styrene-butadiene polymer-modified asphalt emulsion (control) and a polyphosphoric acid-flipped styrene-butadiene polymer-modified asphalt emulsion.

FIG. 7 is a graph showing the particle size distribution of the styrene-butadiene polymer-modified asphalt emulsions exemplified in FIG. 6.

FIG. 8 is a bar graph showing the effect of polyphosphoric acid on the viscosity of carboxylated styrene butadiene modified hot mix asphalt compositions at 135° C.

FIG. 9 is a bar graph showing the effect of polyphosphoric acid on Fresh SHRP of carboxylated styrene butadiene modified hot mix asphalt compositions.

### DETAILED DESCRIPTION

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise. The disclosure of percentage ranges and other ranges herein includes the disclosure of the endpoints of the range and any integers provided in the range.

Disclosed herein are latex compositions (e.g., dispersions) comprising polyphosphoric acid and asphalt compositions comprising the latex compositions. Methods of making and using the compositions described herein are also disclosed. The latex composition can be an aqueous latex dispersion.

The latex compositions include a polymer. In some embodiments, the polymer can be derived from ethylenically unsaturated monomers. For example, the polymer can be a pure acrylic polymer (i.e., a polymer derived exclusively from (meth)acrylate and/or (meth)acrylic acid monomers), a styrene-butadiene copolymer (i.e., a polymer derived from butadiene and styrene monomers), a styrene-butadiene-styrene block copolymer, a vinyl aromatic-acrylic copolymer (i.e., a polymer derived from vinyl aromatic monomers such as styrene and one or more (meth)acrylate and/or (meth)acrylic acid monomers), a vinyl-acrylic copolymer (i.e., a polymer derived from one or more vinyl ester monomers and one or more (meth)acrylate and/or (meth)acrylic acid monomers), a vinyl chloride polymer (i.e., a polymer derived from one or more vinyl chloride monomers), a vinyl alkanoate polymer (i.e., a polymer derived from one or more vinyl alkanoate monomers, such as polyvinyl acetate or a copolymer derived from ethylene and vinyl acetate monomers), or a combination thereof. The term “(meth)acryl . . . ,” as used herein, includes “acryl . . . ,” “methacryl . . . ,” or mixtures thereof. The polymer can be a random copolymer or a block copolymer. In some embodiments, the polymer can include a styrene-butadiene copolymer, polychloroprene, a styrene-butadiene-styrene block copolymer, an ethylene vinyl acetate copolymer, a styrene acrylic copolymer, an acrylic polymer, a vinyl acrylic copolymer, or a combination thereof.

Suitable unsaturated monomers for use in forming the polymer are generally ethylenically unsaturated monomers and include vinylaromatic compounds (e.g. styrene, α-methylstyrene, o-chlorostyrene, and vinyltoluenes); 1,2-butadiene (i.e. butadiene); conjugated dienes (e.g. 1,3-butadiene and isoprene); α,β-monoethylenically unsaturated mono- and dicarboxylic acids or anhydrides thereof (e.g. acrylic acid, methacrylic acid, crotonic acid, dimethacrylic acid, ethylacrylic acid, allylacetic acid, vinylacetic acid maleic acid, fumaric acid, itaconic acid, mesaconic acid, methylenemalonic acid, citraconic acid, maleic anhydride, itaconic anhydride, and methylmalonic anhydride); esters of α,β-monoethylenically unsaturated mono- and dicarboxylic acids having 3 to 6 carbon atoms with alkanols having 1 to 12 carbon atoms (e.g. esters of acrylic acid, methacrylic acid, maleic acid, fumaric acid, or itaconic acid, with C₁-C₁₂, C₁-C₈, or C₁-C₄ alkanols such as ethyl, n-butyl, isobutyl and 2-ethylhexyl acrylates and methacrylates, dimethyl maleate and n-butyl maleate); acrylamides and alkyl-substituted acrylamides (e.g. (meth)acrylamide, N-tert-butylacrylamide, and N-methyl(meth)acrylamide); (meth)acrylonitrile; vinyl and vinylidene halides (e.g. vinyl chloride and vinylidene chloride); vinyl esters of C₁-C₁₈ mono- or dicarboxylic acids (e.g. vinyl acetate, vinyl propionate, vinyl n-butyrate, vinyl laurate and vinyl stearate); C₁-C₄ hydroxyalkyl esters of C₃-C₆ mono- or dicarboxylic acids, especially of acrylic acid, methacrylic acid or maleic acid, or their derivatives alkoxylated with from 2 to 50 moles of ethylene oxide, propylene oxide, butylene oxide or mixtures thereof, or esters of these acids with C₁-C₁₈ alcohols alkoxylated with from 2 to 50 mol of ethylene oxide, propylene oxide, butylene oxide or mixtures thereof (e.g. hydroxyethyl (meth)acrylate, hydroxypropyl (meth)acrylate, and methylpolyglycol acrylate); and monomers containing glycidyl groups (e.g. glycidyl methacrylate).

The polymer can include on more additional monomers. The additional monomers can include, for example, other vinyl aromatic compounds (e.g., α-methylstyrene, o-chlorostyrene, and vinyltoluene); isoprene; anhydrides of α,β-monoethylenically unsaturated monocarboxylic and dicarboxylic acids (e.g., maleic anhydride, itaconic anhydride, and methylmalonic anhydride); other alkyl-substituted acrylamides (e.g., N-tert-butylacrylamide and N-methyl(meth)acrylamide); vinyl and vinylidene halides (e.g., vinyl chloride and vinylidene chloride); vinyl esters of C₁-C₁₈ monocarboxylic or dicarboxylic acids (e.g., vinyl acetate, vinyl propionate, vinyl N-butyrate, vinyl laurate, and vinyl stearate); C₁-C₄ hydroxyalkyl esters of C₃-C₆ monocarboxylic or dicarboxylic acids, for example of acrylic acid, methacrylic acid, or maleic acid, or their derivatives alkoxylated with from 2 to 50 moles of ethylene oxide, propylene oxide, butylene oxide or mixtures thereof, or esters of these acids with C₁-C₁₈ alcohols alkoxylated with from 2 to 50 mol of ethylene oxide, propylene oxide, butylene oxide or mixtures thereof (e.g., hydroxyethyl (meth)acrylate, hydroxypropyl (meth)acrylate, and methylpolyglycol acrylate); monomers containing glycidyl groups (e.g., glycidyl methacrylate); linear 1-olefins, branched-chain 1-olefins or cyclic olefins (e.g., ethene, propene, butene, isobutene, pentene, cyclopentene, hexene, and cyclohexene); vinyl and allyl alkyl ethers having 1 to 40 carbon atoms in the alkyl radical, wherein the alkyl radical can possibly carry further substituents such as a hydroxyl group, an amino or dialkylamino group, or one or more alkoxylated groups (e.g., methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-N-butylamino)ethyl vinyl ether, methyldiglycol vinyl ether, and the corresponding allyl ethers); sulfo-functional monomers (e.g., allylsulfonic acid, methallylsulfonic acid, styrenesulfonate, vinylsulfonic acid, allyloxybenzenesulfonic acid, 2-acrylamido-2-methylpropanesulfonic acid, and their corresponding alkali metal or ammonium salts, sulfopropyl acrylate, and sulfopropyl methacrylate); vinylphosphonic acid, dimethyl vinylphosphonate, and other phosphorus monomers (e.g., phosphoethyl (meth)acrylate); alkylaminoalkyl (meth)acrylates or alkylaminoalkyl(meth)acrylamides or quaternization products thereof (e.g., 2-(N,N-dimethylamino)ethyl (meth)acrylate, 3⁻(N,N-dimethylamino)propyl (meth)acrylate, 2-(N,N,N-trimethylammonium)ethyl (meth)acrylate chloride, 2-dimethylaminoethyl(meth)acrylamide, 3-dimethylaminopropyl(meth)acrylamide, and 3-trimethylammoniumpropyl(meth)acrylamide chloride); allyl esters of C₁-C₃₀ monocarboxylic acids; N-vinyl compounds (e.g., N-vinylformamide, N-vinyl-N-methylformamide, N-vinylpyrrolidone, N-vinylimidazole, 1-vinyl-2-methylimidazole, 1-vinyl-2-methylimidazoline, N-vinylcaprolactam, vinylcarbazole, 2-vinylpyridine, and 4-vinylpyridine); monomers containing 1,3-diketo groups (e.g., acetoacetoxyethyl (meth)acrylate or diacetone acrylamide); monomers containing urea groups (e.g., ureidoethyl (meth)acrylate, acrylamidoglycolic acid, and methacrylamidoglycolate methyl ether); monoalkyl itaconates; monoalkyl maleates; hydrophobic branched ester monomers; monomers containing silyl groups (e.g., trimethoxysilylpropyl methacrylate), vinyl esters of branched mono-carboxylic acids having a total of 8 to 12 carbon atoms in the acid residue moiety and 10 to 14 total carbon atoms such as, vinyl 2-ethylhexanoate, vinyl neo-nonanoate, vinyl neo-decanoate, vinyl neo-undecanoate, vinyl neo-dodecanoate and mixtures thereof, and copolymerizable surfactant monomers (e.g., those sold under the trademark ADEKA REASOAP). In some embodiments, the one or more additional monomers include (meth)acrylonitrile, (meth)acrylamide, or a mixture thereof. In some embodiments, the polymer can include the one or more additional monomers in an amount of greater than 0% to 10% by weight, based on the weight of the polymer. For example, the polymer can include the one or more additional monomers in an amount of 0.5% to 10%, 0.5% to 5%, 0.5% to 4%, 0.5% to 3%, 0.5% to 2%, or 0.5% to 1% by weight, based on the weight of the polymer.

The polymer can include one or more crosslinking monomers. Exemplary crosslinking monomers include N-alkylolamides of α,β-monoethylenically unsaturated carboxylic acids having 3 to 10 carbon atoms and esters thereof with alcohols having 1 to 4 carbon atoms (e.g., N-methylolacrylamide and N-methylolmethacrylamide); glycidyl (meth)acrylate; glyoxal based crosslinkers; monomers containing two vinyl radicals; monomers containing two vinylidene radicals; and monomers containing two alkenyl radicals. Other crosslinking monomers include, for instance, diesters of dihydric alcohols with α,β-monoethylenically unsaturated monocarboxylic acids, of which in turn acrylic acid and methacrylic acid can be employed. Examples of such monomers containing two non-conjugated ethylenically unsaturated double bonds can include alkylene glycol diacrylates and dimethacrylates, such as ethylene glycol diacrylate, 1,3-butylene glycol diacrylate, 1,4-butylene glycol diacrylate and propylene glycol diacrylate, divinylbenzene, vinyl methacrylate, vinyl acrylate, allyl methacrylate, allyl acrylate, diallyl maleate, diallyl fumarate, methylenebisacrylamide, and mixtures thereof. In some embodiments, the polymer can include from 0.01% to 5% by weight of the polymer, of the crosslinking agent.

In some embodiments, the polymer in the latex composition can include styrene, butadiene, and optionally, one or more additional monomers. The styrene can be in an amount of 2% or greater by weight, based on the weight of the polymer. For example, the styrene can be in an amount of 5% or greater, 10% or greater, 20% or greater, 30% or greater, 40% or greater, 50% or greater, 60% or greater, or 70% or greater, by weight, based on the weight of the polymer. In some embodiments, the styrene can be in an amount of 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the polymer. The butadiene can be in an amount of 2% by weight of the polymer. For example, the butadiene can be in an amount of 5% or greater, 10% or greater, 20% or greater, 30% or greater, 40% or greater, 50% or greater, 60% or greater, or 70% or greater by weight, based on the weight of the polymer. In some embodiments, the butadiene can be in an amount of 95% or less, 90% or less, 85% or less, 80% or less, 75% or less, 70% or less, 65% or less, 60% or less, 55% or less, 50% or less, 45% or less, 40% or less, 35% or less, 30% or less, or 25% or less, by weight, based on the weight of the polymer. In some embodiments, the weight ratio of styrene to butadiene monomers in the polymer can be from 1:99 to 99:1, from 20:80 to 80:20, from 30:70 to 70:30, or from 40:60 to 60:40. For example, the weight ratio of styrene to butadiene can be 25:75 or greater, 30:70 or greater, 35:65 or greater, or 40:60 or greater.

The styrene butadiene copolymer can include a carboxylic acid monomer. In some embodiments, the polymer can include a carboxylated styrene-butadiene copolymer derived from styrene, butadiene, and a carboxylic acid monomer. In some embodiments, the polymer can be derived from 0.5%-10%, 1-9%, or 2-8% by weight of a carboxylic acid monomer. Suitable carboxylic acid monomers include (meth)acrylic acid, itaconic acid, fumaric acid, or mixtures thereof. In some embodiments, the polymer can include a non-carboxylated styrene-butadiene copolymer (i.e., not derived from a carboxylic acid monomer). In some embodiments, the polymer includes one or more of the other monomers provided above.

In some embodiments, the polymer in the latex composition can be a styrene-butadiene copolymer. Suitable commercially available styrene-butadiene copolymers can include BUTONAL® NX1118, BUTONAL® NX 1138, BUTONAL® NX 4190, and BUTONAL® NS 198, commercially available from BASF Corporation.

The latex composition can be an aqueous latex dispersion including particles of the polymer dispersed in water. In some embodiments, the latex composition can be prepared with a total solids content of from 5% to 90% by weight, for example, 10% to 80% by weight, 20% to 70% by weight, 25% to 65% by weight, 35% to 60% by weight, or 45% to 60% by weight, based on the weight of the latex composition. In some embodiments, the latex composition can have a total solids content of 40% or greater or 50% or greater by weight, based on the weight of the latex composition. In some embodiments, the latex composition can have a total solids content of 90% or less, 80% or less, or 70% or less by weight, based on the weight of the latex composition. The polymer particles in the latex composition can have an average particle size of from 20 nm to 5000 nm, such as from 20 nm to 1000 nm, from 30 nm to 500 nm, or from 50 nm to 250 nm. The particle size of the polymer particles can be measured using dynamic light scattering measurements, for example using a Nicomp Model 380 available from Particle Sizing Systems, Santa Barbara, Calif.

The latex composition can include one or more surfactants (emulsifiers) such as nonionic surfactants, anionic surfactants, cationic surfactants, amphoteric surfactants, or a mixture thereof. In some embodiments, the latex compositions include an amine derived surfactant. Suitable surfactants include polyamines, fatty amines, fatty amido-amines, ethoxylated amines, diamines, imidazolines, quaternary ammonium salts, and mixtures thereof. Examples of commercially available surfactants that can be used in the latex composition include those available from Akzo Nobel under the REDICOTE® trademark (such as REDICOTE® 4819, REDICOTE® E-64R, REDICOTE® E-5, REDICOTE® E-9, REDICOTE® E9A, REDICOTE® E-11, REDICOTE® E-16, REDICOTE® E-44, REDICOTE® E-120, REDICOTE® E-250, REDICOTE® E-2199, REDICOTE® E-4868, REDICOTE® C-346, REDICOTE® C-404, REDICOTE® C-450, and REDICOTE® C-471), surfactants available from MeadWestvaco under the INDULIN® and AROSURF® trademarks (such as INDULIN® 814, INDULIN® AMS, INDULIN® DF-30, INDULIN® DF-40, INDULIN® DF-42, INDULIN® DF-60, INDULIN® DF-80, INDULIN® EX, INDULIN® FRC, INDULIN® MQK, INDULIN® MQK-1M, INDULIN® MQ3, INDULIN® QTS, INDULIN® R-20, INDULIN® SBT, INDULIN® W-1, and INDULIN® W-5), ASFIER® N480 available from Kao Specialties Americas, CYPRO™ 514 available from Cytec Industries, polyethyleneimines such as those available from BASF under the POLYMIN® trademark (such as POLYMIN® SK, POLYMIN® SKA, POLYMIN® 131, POLYMIN® 151, POLYMIN® 8209, POLYMIN® P, and POLYMIN® PL), and polyvinylamines such as those available from BASF under the CATIOFAST® trademark (such as CATIOFAST® CS, CATIOFAST® FP, CATIOFAST® GM, and CATIOFAST® PL).

The latex composition can include an antioxidant to prevent oxidation of, for example, the double bonds of the styrene butadiene polymer. Suitable antioxidants can include substituted phenols or secondary aromatic amines. The composition can include antiozonants to prevent ozone present in the atmosphere from, for example, cracking the styrene butadiene polymer, by cleaving the double bonds of the styrene butadiene polymer. The latex composition can include prevulcanization inhibitors to prevent premature vulcanization or scorching of the polymer. Suitable antioxidants, antiozonants, and prevulcanization inhibitors are disclosed in U.S. Pat. No. 8,952,092. The antioxidants, antiozonants, and/or prevulcanization inhibitors can be provided in an amount from 1% to 5% by weight, based on the weight of the solids in the latex composition.

The latex compositions described herein can include an inorganic phosphorous-containing compound. In some embodiments, the latex compositions can include polyphosphoric acid. Polyphosphoric acid can be produced from the dehydration of H₃PO₄ at high temperatures or by heating P₂O₅ dispersed in H₃PO₄. The polyphosphoric acid in the latex compositions can include a compound represented by the formula, Hₙ₊₂PₙO₃ₙ₊₁, wherein n is an integer from 2 to 30. In some examples, n is from 2 to 25, 2 to 20, 2 to 15, or 2 to 10. In some embodiments, n can be 2 or greater, 3 or greater, 4 or greater, 5 or greater, 6 or greater, 7 or greater, 8 or greater, 9 or greater, 10 or greater, 12 or greater, of 15 or greater. In some embodiments, n can be 20 or less, 15 or less, 10 or less, or 5 or less. In some embodiments, the latex composition does not include an organic phosphorous-containing compound, such as an organic polyphosphoric acid compound.

The amount of polyphosphoric acid in the latex composition can be 0.05% by weight or greater, based on the total weight of the latex composition. For example, the latex composition can include 0.1% or greater, 0.2% or greater, 0.3% or greater, 0.5% or greater, 0.6% or greater, 0.7% or greater, 0.8% or greater, 0.9% or greater, 1% or greater, 1.5% or greater, 2% or greater, 2.5% or greater, 3% or greater, 3.5% or greater, 4% or greater, 4.5% or greater, 5% or greater, 6% or greater, 7% or greater, 8% or greater, 9% or greater, 10% or greater, 11% or greater, 12% or greater, 13% or greater, or 14% or greater by weight of the latex composition, of polyphosphoric acid. In some embodiments, the latex composition can include 15% or less, 12% or less, 10% or less, 7% or less, 5% or less, 4% or less, 3% or less, 2% or less or 1% or less by weight of the latex composition, of polyphosphoric acid. In some embodiments, the latex composition can include from 0.05 to 15%, 0.1% to 10%, 0.5 to 15%, or 1% to 10% by weight of the latex composition, of polyphosphoric acid.

The latex composition can include an additional inorganic acid. In some embodiments, the latex composition can include an additional inorganic acid selected from hydrochloric acid, sulfuric acid, phosphoric acid, C₁-C₁₄ organic acids such as acetic acid, formic acid, citric acid, tartaric acid, and mixtures thereof. In some embodiments, the latex composition can include phosphoric acid. In some embodiments, the latex composition can include polyphosphoric acid and phosphoric acid. In some embodiments, the latex compositions does not include an inorganic acid in addition to polyphosphoric acid and phosphoric acid.

The additional inorganic acid can be present in an amount of from 0% to 3% by weight, based on the total weight of the latex composition. In some embodiments, the latex composition can include 0.3% or greater, 0.5% or greater, 1% or greater, 1.5% or greater, 2% or greater, or 2.5% or greater by weight of the latex composition, of the additional inorganic acid. In some embodiments, the latex composition can include 3% or less, 2.5% or less, 2.0% or less, 1.5% or less, 1.0% or less, or 0.5% or less by weight of the latex composition, of the additional inorganic acid. In some embodiments, the latex composition can include from 0.3 to 3%, 0.5% to 3%, or 1% to 3% by weight of the latex composition, of the additional inorganic acid. In some embodiments, the additional inorganic acid can be in an amount such that the pH of the latex composition or asphalt compositions thereof, can be from 1 to 5, such as from 2 to 4 or from 3 to 5. In some embodiments, the latex composition does not include an additional acid, that is, in addition to polyphosphoric acid.

The latex composition can be cationic, anionic, or non-ionic. In some embodiments, the latex composition can be cationic. For example, the latex composition can include a cationic surfactant such as an amine-containing surfactant at a suitable pH (e.g., below the pKa of the cationic surfactant). In some embodiments, the latex composition can be anionic. For example, the latex composition can include a carboxylated polymer, such as a carboxylated styrene butadiene copolymer. In some embodiments, the latex composition (including the cationic, anionic, or non-ionic latex composition) can have a pH of 7 or less. For example, the latex composition can have a pH of 6.5 or less, 6 or less, 5.5 or less, 5 or less, 4.5 or less, 4 or less, or 3.5 or less. In some examples, the latex composition can have a pH of 2 or greater, 2.5 or greater, 3 or greater, 3.5 or greater, 4 or greater, 4.5 or greater, 5 or greater, 5.5 or greater, 6 or greater, 6.5 or greater, or 7 or greater. In some embodiments, the latex composition can have a pH of from 2 to 7, from 2 to 6.5, from 2 to 6, from 3 to 7, from 3 to 6.5, from 3 to 6, from 4 to 7, from 4 to 6.5, or from 4 to 6.

Asphalt compositions or formulations comprising the latex compositions described herein are also disclosed. The term “asphalt” as used herein, includes the alternative term “bitumen.” Thus, the asphalt formulations can be termed bitumen formulations. “Asphalt compositions” or “asphalt formulations” as used herein, include asphalt emulsions and hot-mix asphalt compositions. In some embodiments, the asphalt formulations can include asphalt, a latex composition, and a sulfur curing agent. The asphalt can be molten asphalt. The asphalt formulations can include 50% or greater by weight of the asphalt formulation, of asphalt. In some embodiments, the asphalt formulations can include 55% or greater, 60% or greater, 65% or greater, 70% or greater, 75% or greater, 80% or greater, 85% or greater, 90% or greater, 95% or greater, or 99% or greater by weight of the asphalt formulation, of asphalt. In some embodiments, the asphalt formulations can include 99.9% or less, 99% or less, 95% or less, 90% or less, 87% or less, 85% or less, 83% or less, or 80% or less by weight of the asphalt formulation, of asphalt. In some embodiments, the asphalt formulations can include 50% to 95%, 50% to 90%, 50% to 85%, 50% to 80%, 60% to 95%, 60% to 90%, or 60% to 80% by weight of the asphalt formulation, of asphalt.

The latex composition can be in an amount of 0.5% or greater by weight, based on the weight of the asphalt formulation. In some embodiments, the asphalt formulations can include the latex composition in an amount of 1% or greater, 1.5% or greater, 2% or greater, 2.5% or greater, 3% or greater, 3.5% or greater, 4% or greater, 4.5% or greater, 5% or greater, 6% or greater, 7% or greater, 8% or greater, 9% or greater, 10% or greater, 11% or greater, 12% or greater, 13% or greater, or 14% or greater by weight, based on the weight of the asphalt formulation. In some embodiments, the asphalt formulations can include the latex composition in an amount of 15% or less, 12% or less, 10% or less, 8% or less, 7% or less, 6% or less, 5% or less, 4% or less, 3% or less, 2% or less, or 1% or less by weight, based on the weight of the asphalt formulation. In some embodiments, the asphalt formulations can include the latex composition in an amount of 0.5% to 15%, 0.5% to 12%, 0.5% to 10%, 1% to 15%, or 1% to 10% by weight, based on the weight of the asphalt formulation.

The asphalt composition can include asphalt, a polymer, polyphosphoric acid, and a sulfur curing agent. In some embodiments, the polymer can be selected from styrene-butadiene copolymers, polychloroprene, styrene-butadiene-styrene block copolymers, ethylene vinyl acetate copolymers, styrene acrylic copolymers, pure acrylic polymers, vinyl acrylic copolymers, and combinations thereof. In some embodiments, the asphalt emulsion is cationic, for example, by including a cationic surfactant. In some embodiments, the asphalt emulsion is anionic, for example, by including a carboxylated styrene butadiene polymer.

The asphalt composition can include the polymer in an amount of about one half the amount provided above for the latex compositions as the polymer can be present in an amount of 50-55% solids in the latex composition. In some embodiments, the asphalt formulations can include the polymer in an amount of 0.25% or greater, 0.5% or greater, 0.75% or greater, 1% or greater, 1.5% or greater, 2% or greater, 2.5% or greater, 3% or greater, 3.5% or greater, 4% or greater, 4.5% or greater, 5% or greater, 6% or greater, 7% or greater, 8% or greater, 9% or greater, or 10% or greater by weight, based on the weight of the asphalt formulation. In some embodiments, the asphalt formulations can include the polymer in an amount of 10% or less, 8% or less, 7% or less, 6% or less, 5% or less, 4% or less, 3% or less, 2% or less, 1% or less, or 0.5% or less by weight, based on the weight of the asphalt formulation. In some embodiments, the asphalt formulations can include the polymer in an amount of 0.25% to 10%, 0.5% to 10%, 0.5% to 6%, 0.5% to 5%, or 1% to 5% by weight, based on the weight of the asphalt formulation.

As described herein, the latex composition can include polyphosphoric acid. In some embodiments, the asphalt formulations can include the latex composition in an amount, such that the amount of polyphosphoric acid is from 0.0003% to 1%, 0.0003% to 0.5%, 0.001% to 0.5%, or 0.01% to 0.5% by weight, based on the weight of the asphalt formulation. In some embodiments, the asphalt formulations can include the latex composition in an amount, such that the amount of polyphosphoric acid is from 0.2% to 1% by weight, based on the weight of the asphalt formulation.

The asphalt formulations can be vulcanized or cured to crosslink the polymer in the latex composition, thereby increasing the tensile strength and elongation of the polymer. In some embodiments, the asphalt formulations can include vulcanizing (curing) agents, vulcanization accelerators, antireversion agents, or a combination thereof. In some embodiments, the vulcanizing agents, vulcanization accelerators, and/or antireversion agents can be included in the latex composition. Exemplary vulcanizing agents are sulfur curing agents and include various kinds of sulfur such as sulfur powder, precipitated sulfur, colloidal sulfur, insoluble sulfur and high-dispersible sulfur; sulfur halides such as sulfur monochloride and sulfur dichloride; sulfur donors such as 4,4′-dithiodimorpholine; selenium; tellurium; organic peroxides such as dicumyl peroxide and di-tert-butyl peroxide; quinone dioximes such as p-quinone dioxime and p,p′-dibenzoylquinone dioxime; organic polyamine compounds such as triethylenetetramine, hexamethylenediamine carbamate, 4,4′-methylenebis(cyclohexylamine) carbamate and 4,4′-methylenebis-o-chloroaniline; alkylphenol resins having a methylol group; and mixtures thereof. The vulcanizing agent can be present from 0.01 to 1% or from 0.01 to 0.6% by weight, based on the weight of the asphalt formulation.

Exemplary vulcanization accelerators include sulfenamide-type vulcanization accelerators such as N-cyclohexyl-2-benzothiazole sulfenamide, N-t-butyl-2-benzothiazole sulfenamide, N-oxyethylene-2-benzothiazole sulfenamide, N-oxydiethylene-2-benzothiazole sulfenamide, N-oxydiethylene-thiocarbamyl-N-oxydiethylene sulfenamide, N-oxyethylene-2-benzothiazole sulfenamide and N, N′-diisopropyl-2-benzothiazole sulfenamide; guanidine-type vulcanization accelerators such as diphenylguanidine, di-o-tolylguanidine and di-o-tolylbiguanidine; thiourea-type vulcanization accelerators such as thiocarboanilide, di-o-tolylthiourea, ethylenethiourea, diethylenethiourea, dibutylthiourea and trimethylthiourea; thiazole-type vulcanization accelerators such as 2-mercaptobenzothiazole, dibenzothiazyl disulfide, 2-mercaptobenzothiazole zinc salt, 2-mercaptobenzothiazole sodium salt, 2-mercaptobenzothiazole cyclohexylamine salt, 4-morpholinyl-2-benzothiazole disulfide and 2-(2,4-dinitrophenylthio)benzothiazole; thiadiazine-type vulcanization accelerators such as activated thiadiazine; thiuram-type vulcanization accelerators such as tetramethylthiuram monosulfide, tetramethylthiuram disulfide, tetraethylthiuram disulfide, tetrabutylthiuram disulfide and dipentamethylenethiuram tetrasulfide; dithiocarbamic acid-type vulcanization accelerators such as sodium dimethyldithiocarbamate, sodium diethyldithiocarbamate, sodium di-n-butyldithiocarbamate, lead dimethyldithiocarbamate, lead diamyldithiocarbamate, zinc diamyldithiocarbamate, zinc dimethyldithiocarbamate, zinc diethyldithiocarbamate, zinc di-n-butyldithiocarbamate, zinc pentamethylene dithiocarbamate, zinc ethylphenyldithiocarbamate, tellurium diethyldithiocarbamate, bismuth dimethyldithiocarbamate, selenium dimethyldithiocarbamate, selenium diethyldithiocarbamate, cadmium diethyldithiocarbamate, copper dimethyldithiocarbamate, iron dimethyldithiocarbamate, diethylamine diethyldithiocarbamate, piperidinium pentamethylene dithiocarbamate and pipecoline pentamethylene dithiocarbamate; xanthogenic acid-type vulcanization accelerators such as sodium isopropylxanthogenate, zinc isopropylxanthogenate and zinc butylxanthogenate; isophthalate-type vulcanization accelerators such as dimethylammonium hydrogen isophthalate; aldehyde amine-type vulcanization accelerators such as butyraldehyde-amine condensation products and butyraldehyde-monobutylamine condensation products; and mixtures thereof. The vulcanization accelerator can be present in an amount of from 0.01 to 1% or from 0.01 to 0.6% by weight, based on the weight of the asphalt formulation.

Antireversion agents can also be included to prevent reversion, i.e., an undesirable decrease in crosslink density. Suitable antireversion agents include zinc salts of aliphatic carboxylic acids, zinc salts of monocyclic aromatic acids, bismaleimides, biscitraconimides, bisitaconimides, aryl bis-citraconamic acids, bissuccinimides, and polymeric bissuccinimide polysulfides (e.g., N, N′-xylenedicitraconamides). The antireversion agent can be present in an amount of from 0.01 to 1% or from 0.01 to 0.6% by weight, based on the weight of the asphalt formulation.

The asphalt formulations can include a basic salt. Suitable basic salts can include the salt of a strong base and a weak acid. In some embodiments, the asphalt formulations can include a basic salt selected from sodium sulfate, potassium sulfate, magnesium sulfate, aluminum sulfate, iron sulfate, cobalt sulfate, barium sulfate, beryllium sulfate, copper sulfate, zinc sulfate, manganese sulfate, sodium carbonate, sodium bicarbonate, potassium carbonate, potassium bicarbonate, potassium sodium carbonate, sodium bisulfate, ammonium bisulfite, potassium bisulfate, potassium sulfite, sodium sulfite, potassium hydrogen sulfite, ammonium sulfite, disodium hydrogen phosphate, sodium dihydrogen phosphate, dipotassium hydrogen phosphate, and mixtures thereof. In some embodiments, the basic salt can include aluminum sulfate.

The basic salt, such as aluminum sulfate can be in an amount of 0.01% by weight or greater by weight, based on the weight of the asphalt formulation. In some embodiments, the asphalt formulation can include the basic salt in an amount of 0.05% or greater, 0.1% or greater, 0.25% or greater, 0.5% or greater, 0.75% or greater, 1% or greater, 1.5% or greater, 2% or greater, or 2.5% or greater by weight, based on the weight of the asphalt formulation. In some embodiments, the asphalt formulation can include the basic salt in an amount of 5% or less, 4% or less, 3% or less, 2% or less, 1.5% or less, 1% or less, or 0.5% or less by weight, based on the weight of the asphalt formulation. In some embodiments, the asphalt formulation can include the basic salt in an amount of 0.01% to 5%, 0.05% to 4%, 0.1% to 5%, 0.2% to 4%, or 0.3% to 3%, by weight, based on the weight of the asphalt formulation. The asphalt formulation can include the basic salt in an amount such that the pH of the asphalt formulation has a pH of from 1.5 to 10, such as from 1.5 to 6 or from 8 to 10.

The asphalt formulations can include a solvent such as water to disperse or emulsify the polymer and/or the asphalt. The asphalt formulation can include water in an amount of 1% to 35%, 5% to 30%, or 5% to 25% by weight, based on the weight of the asphalt formulation.

The asphalt formulations can further include one or more additional additives. Suitable additional additives include chloride salts, thickeners, and fillers. Chloride salts can be added, for example to improve emulsifiability, in an amount of up to 1 part by weight. Suitable chloride salts include sodium chloride, potassium chloride, calcium chloride, aluminum chloride, or mixtures thereof. Thickeners can be added in an amount of 0.5 parts by weight or greater and can include associative thickeners, polyurethanes, alkali swellable latex thickeners, cellulose, cellulose derivatives, modified cellulose products, plant and vegetable gums, starches, alkyl amines, polyacrylic resins, carboxyvinyl resins, polyethylene maleic anhydrides, polysaccharides, acrylic copolymers, hydrated lime (such as cationic and/or nonionic lime), or mixtures thereof. In some embodiments, the asphalt formulations described herein do not include a thickener. Mineral fillers and/or pigments can include calcium carbonate (precipitated or ground), kaolin, clay, talc, diatomaceous earth, mica, barium sulfate, magnesium carbonate, vermiculite, graphite, carbon black, alumina, silicas (fumed or precipitated in powders or dispersions), colloidal silica, silica gel, titanium oxides (e.g., titanium dioxide), aluminum hydroxide, aluminum trihydrate, satine white, magnesium oxide, hydrated lime, limestone dust, Portland cement, silica, alum, fly ash, or mixtures thereof. Fillers such as mineral fillers and carbon black can be included in an amount of up to 5 parts by weight or up to 2 parts by weight.

The asphalt formulations can also include an aggregate. The aggregate can be of varying sizes as would be understood by those of skill in the art. Any aggregate that is traditionally employed in the production of bituminous paving compositions can be used, including dense-graded aggregate, gap-graded aggregate, open-graded aggregate, reclaimed asphalt pavement, and mixtures thereof. In some embodiments, the asphalt formulation can include an aggregate in an amount of 1% to 90% by weight, based on the weight of the asphalt formulation. In some embodiments, the asphalt formulation can include an aggregate in an amount of 90% or less, 85% or less, 80% or less, 75% or less, 70% or less, 65% or less, 60% or less, 55% or less, 50% or less, or 45% or less by weight, based on the weight of the asphalt formulation. In some embodiments, the asphalt formulation can include an aggregate in an amount of 5% or greater, 10% or greater, 15% or greater, 20% or greater, 25% or greater, 30% or greater, 35% or greater, 40% or greater, 45% or greater, or 50% or greater by weight, based on the weight of the asphalt formulation.

In some embodiments, the asphalt formulation can have a pH of 7 or less. For example, the asphalt formulation can have a pH of 6.5 or less, 6 or less, 5.5 or less, 5 or less, 4.5 or less, 4 or less, 3.5 or less, 3 or less, or 2.5 or less. In some examples, the asphalt formulation can have a pH of 1.5 or greater, 2 or greater, 2.5 or greater, 3 or greater, 3.5 or greater, 4 or greater, 4.5 or greater, 5 or greater, 5.5 or greater, 6 or greater, 6.5 or greater, or 7 or greater. In some embodiments, the asphalt formulation can have a pH of from 1.5 to 7, from 2 to 6.5, from 1.5 to 6, from 2 to 6, from 3 to 7, from 3 to 6.5, from 3 to 6, from 4 to 7, from 4 to 6.5, or from 4 to 6.

Methods

Methods for preparing the latex compositions described herein are also provided. A latex composition can be prepared by polymerizing monomers, such as styrene monomers, butadiene monomers, and optionally additional monomers in an aqueous emulsion polymerization reaction at a suitable temperature. The polymerization can be carried out at low temperature (i.e., cold polymerization) or at high temperature method (i.e., hot polymerization). In some embodiments, polymerization can be carried out at low temperature such as 30° C. or less (for example from 2° C. to 30° C., 2° C. to 25° C., 5° C. to 30° C., or 5° C. to 25° C.). In some embodiments, polymerization can be carried out at high temperature such as from 40° C. or greater, 50° C. or greater, or 60° C. or greater. In some embodiments, the high temperature can be from 40° C. to 100° C., 40° C. to 95° C., or 50° C. to 90° C.

The polymerized polymer can be produced using either a continuous, semi-batch (semi-continuous) or batch process. In some examples, the polymer can be produced using a continuous method by continuously feeding one or more monomer streams, a surfactant stream, and an initiator stream to one or more reactors. The surfactant stream includes a surfactant and water and can, in some embodiments, be combined with the initiator stream.

The polymerization reaction can be conducted in the presence of molecular weight regulators to reduce the molecular weight of the copolymer of other additives such as dispersants, stabilizers, chain transfer agents, buffering agents, salts, preservatives, fire retardants, wetting agents, protective colloids, biocides, crosslinking promoters, antioxidants, antiozonants, prevulcanization inhibitors, and lubricants. In some embodiments, the additives can be added to the latex composition after the polymerization reaction. The latex composition can be agglomerated, e.g., using chemical, freeze or pressure agglomeration, and water removed to produce the desired solids content. In some embodiments, the solids content is 55% or greater, 60% or greater, or 65% or greater.

In some embodiments, the latex composition can have an overall anionic charge, non-ionic, or cationic charge. One of ordinary skill in the art understands that the overall charge of the latex composition can be influenced by the surfactant used, the particular monomers used to form the polymer in the latex composition, and the pH of the latex composition. The charge of an anionic latex composition or a non-ionic latex composition can be “flipped” (modified) to an overall cationic charge, thereby forming a cationic latex composition. In some embodiments, the cationic latex composition can be formed by mixing the latex composition with an inorganic acid. For example, the method can include mixing the latex composition with phosphoric acid or hydrochloric acid to form the cationic latex composition. The cationic latex composition is then mixed with polyphosphoric acid. In some embodiments, the method can include mixing the anionic or nonionic latex composition with polyphosphoric acid to form the cationic latex composition. In certain embodiments, the cationic latex composition does not include an inorganic acid in addition to polyphosphoric acid.

The cationic latex compositions can be used in asphalt formulations prepared at an elevated temperature, for example, from 160° C. to 200° C. (hot-mix asphalt), from 120° C. to 160° C. (warm-mix asphalt), or at temperatures below 120° C. (e.g., from 5° C. to less than 100° C., from 10° C. to 90° C., or from 20° C. to 85° C.). In some embodiments, the cationic latex compositions can be used in asphalt emulsions prepared less than 100° C., e.g., at ambient temperature, to produce a polymer-modified asphalt emulsion.

The method of preparing the asphalt emulsions can include contacting asphalt with a latex composition as described herein and a sulfur curing agent. In some embodiments, the asphalt emulsion is cationic. The method can further include contacting the asphalt with a basic salt, such as aluminum sulfate. The particular components, including the asphalt, the latex composition, the sulfur curing agent, and the basic salt in the asphalt emulsions can be mixed together by any means known in the art. The particular components can be mixed together in any order. In some embodiments, the latex composition and the asphalt can be fed into a colloid mill at a temperature of less than 100° C. (e.g., 60° C. to 95° C.) where high shear mixing produces an asphalt emulsion having asphalt droplets dispersed in the water. The sulfur curing agent and/or the basic salt can be added simultaneously or post-added to the asphalt emulsion (comprising the latex composition and asphalt). In some embodiments, the latex composition and the sulfur curing agent are mixed with the asphalt simultaneously. For example, the latex composition can include the sulfur curing agent such that the polymer, polyphosphoric acid, and the sulfur curing agent are simultaneously mixed with the asphalt. In some embodiments, the basic salt can be combined directly with the asphalt prior to mixing with the other ingredients. In some embodiments, the basic salt can be combined directly with the latex composition prior to mixing with the asphalt. In some embodiments, the polyphosphoric acid, the sulfur curing agent, and the basic salt can all be provided in the latex dispersion and the latex dispersion contacted with the asphalt such as in a colloid mill.

The droplets in the asphalt emulsion can have a narrow particle size distribution. In some embodiments, the droplets in the asphalt emulsion can have a median particle size of 15 μm or less, 14 μm or less, 13 μm or less, 12 μm or less, 11 μm or less, 10 μm or less, 9 μm or less, 8 μm or less, 7 μm or less, 6 μm or less, or 5 μm or less and/or of 5 μm or greater, 6 μm or greater, 7 μm or greater, 8 μm or greater, 9 μm or greater, or 10 μm or greater. In some embodiments, the droplets in the asphalt emulsion can have a mean particle size of 15 μm or less, 14 μm or less, 13 μm or less, 12 μm or less, 11 μm or less, 10 μm or less, 9 μm or less, 8 μm or less, 7 μm or less, 6 μm or less, or 5 μm or less and/or of 5 μm or greater, 6 μm or greater, 7 μm or greater, 8 μm or greater, 9 μm or greater, or 10 μm or greater. In some embodiments, the droplets in the asphalt emulsion can have a median particle size of from 3 to 15 μm. In some embodiments, the droplets in the asphalt emulsion can have a median distribution of droplet particles having a standard deviation of less than 30%, less than 25%, less than 20%, less than 15%, or less than 10%. In some embodiments, the droplets in the asphalt emulsions comprising the cationic latex composition can have a narrower particle size distribution than an asphalt emulsion that does not include the cationic latex composition.

The asphalt emulsions can have a viscosity of 100 cp or greater, when the asphalt is present in an amount of 65% by weight, based on the asphalt emulsion, in the absence of a thickener. In the event the asphalt content is less than or greater than 65% by weight, the asphalt content can be adjusted by adding or removing water. In some embodiments, the asphalt emulsions can have a viscosity of 150 cp or greater, 200 cp or greater, 250 cp or greater, 300 cp or greater, 350 cp or greater, 400 cp or greater, 450 cp or greater, 500 cp or greater, 600 cp or greater, 700 cp or greater, 800 cp or greater, 900 cp or greater, 1000 cp or greater, 1500 cp or greater, 2000 cp or greater, or 2500 cp or greater, at 60° C. as determined using a Brookfield viscometer, spindle #3 at 20 rpm, when the asphalt is present in an amount of 65% by weight, based on the asphalt emulsion. In some embodiments, the asphalt emulsions can have a viscosity of 2500 cp or less, 2000 cp or less, 1500 cp or less, 1250 cp or less, 1000 cp or less, 950 cp or less, 900 cp or less, 850 cp or less, 800 cp or less, 750 cp or less, 700 cp or less, 650 cp or less, 600 cp or less, 550 cp or less, 500 cp or less, 400 cp or less, 250 cp or greater, 300 cp or less, or 200 cp or less, at 60° C. as determined using a Brookfield viscometer, spindle #3 at 20 rpm, when the asphalt is present in an amount of 65% by weight, based on the asphalt emulsion. In some embodiments, the viscosity of the asphalt emulsions can be from 100 cp to 2500 cp, for example, 100 cp to 1500 cp, 100 cp to 1000 cp, 100 cp to 800 cp, 100 cp to 600 cp, 100 cp to 500 cp, 200 cp to 1500 cp, 200 cp to 1000 cp, 200 cp to 800 cp, 200 cp to 600 cp, 200 cp to 500 cp, 100 cp to 500 cp, 100 cp to 450 cp, or 150 cp to 500 cp, at 60° C. as determined using a Brookfield viscometer, spindle #3 at 20 rpm, when the asphalt is present in an amount of 65% by weight, based on the asphalt emulsion. In some embodiments, the addition of the latex composition and the sulfur curing agent to the asphalt emulsion can result in an increase in viscosity of 5 times or greater, 10 times or greater, 15 times or greater, or 20 times or greater, compared to an asphalt emulsion without the latex composition and the sulfur curing agent.

In some embodiments, the (polymer-modified) asphalt emulsion has a softening point that is 5° C. or greater, 10° C. or greater, or 15° C. or greater than the softening point of the same asphalt emulsion without polyphosphoric acid. In some embodiments, the asphalt emulsion using a PG 58-28 base asphalt can have a softening point of 65° C. or greater (for example, 70° C. or greater, 75° C. or greater, or 80° C. or greater). In some embodiments, the asphalt emulsion using a PG 58-28 base asphalt can have a softening point of 85° C. or less (for example, 80° C. or less, 75° C. or less, or 70° C. or less). In some embodiments, the asphalt emulsion using a PG 58-28 base asphalt can have a softening point of from 65° C. to 85° C. or from 70° C. to 80° C. The Ring and Ball Softening Point test, such as those described in ASTM D36 and/or AASHTO T53, can be used to measure the temperature at which an asphalt composition becomes soft and flowable.

The asphalt emulsions described herein can adhere to the standards of ASTM D977, ASTM D2397, AASHTO M140, and AASHTO M208.

The latex composition can be used to prepare polymer-modified, hot mix asphalt compositions. A hot mix asphalt can be prepared, for example, by blending asphalt and a latex composition as described herein at a blending temperature exceeding the boiling point of water. In some embodiments, the latex composition can have a pH of 7 or less as described herein. In some embodiments, the latex composition can be anionic. For example, the latex composition can include a carboxylated polymer. In some embodiments, the latex composition can be nonionic. In some embodiments, the latex composition can be cationic, for example, by including a cationic surfactant. In some embodiments, the latex composition can include a sulfur curing agent. The blending temperature can be 150° C. or greater or 160° C. or greater and 200° C. or less. The hot mix asphalt composition is substantially free of water and can have, for example, a viscosity of 3000 cp or less, 2500 cp or less, 2000 cp or less, or 1500 cp or less at 135° C., at 60° C. as determined using a Brookfield viscometer, spindle #3 at 20 rpm, when the asphalt is present in an amount of 95% by weight, based on the hot mix asphalt compositions. In some embodiments, the hot-mix asphalt composition can have a viscosity of 1000 cp or greater, 1250 cp or greater, 1500 cp or greater, 2000 cp or greater, or 2500 cp or greater, at 60° C. as determined using a Brookfield viscometer, spindle #3 at 20 rpm, when the asphalt is present in an amount of 95% by weight, based on the hot mix asphalt compositions. In some embodiments, the viscosity of the hot-mix asphalt composition can be from 1000 cp to 3000 cp, for example, 1000 cp to 2500 cp, 1000 cp to 2000 cp, 1500 cp to 2500 cp, or 1500 cp to 2000 cp, at 60° C. as determined using a Brookfield viscometer, spindle #3 at 20 rpm, when the asphalt is present in an amount of 95% by weight, based on the hot mix asphalt compositions. The latex composition can be in the amounts described above when added to the hot mix asphalt, but the resulting hot mix asphalt will include less of the latex composition because the water is evaporated leaving the latex polymer and any other non-volatile additives. For example, the latex polymer can be present in a hot mix asphalt compositions in an amount of from 0.05 wt % to 10 wt % (e.g., from 0.5 wt % to 3 wt %), based on the weight of the hot mix asphalt composition.

In some embodiments, the hot mix asphalt composition comprises asphalt, a polymer as described herein, polyphosphoric acid, and a sulfur curing agent. In some embodiments, the hot mix asphalt composition has a pH of 7 or less, or 6 or less (e.g., 1.5 to 6), as described herein.

In some embodiments, the hot mix asphalt composition has a softening point that is 5° C. or greater, 10° C. or greater, or 15° C. or greater than the softening point of the same hot mix asphalt composition without polyphosphoric acid. In some embodiments, the hot mix asphalt compositions can have a softening point of 75° C. or greater or 80° C. or greater using a PG 58-28 base asphalt. Without wishing to be bound by theory, it is believed that there is a synergistic action of the blend of polyphosphoric acid and latex polymer in improving the asphalt's performance. In particular, it is believed that simultaneous addition of polyphosphoric acid and the latex polymer (i.e., in the form of the latex composition) to the asphalt formulation helps the compatibility of the latex polymer with the asphaltenes in asphalt resulting in improved performance compared to compositions that do not include polyphosphoric acid. The better dispersion of asphaltenes and the increased asphaltene content result in a domain-in-matrix reinforcement for the asphaltic material. The latex composition can enhance the asphalt's elasticity to a level above that of the latex polymer alone or polyphosphoric acid alone. As a result of the increased elasticity, asphalt emulsions and hot mix asphalt compositions modified with the latex composition as disclosed herein show improved performance.

In some examples, asphalt emulsions comprising a basic salt, such as aluminum sulfate, can exhibit increased drying times compared to an asphalt emulsion without the basic salt. Without wishing to be bound by any theory, it is believed that aluminum sulfate, for example, due to its basic nature can destabilize cationic emulsions which may be acidic. A possible mechanism includes the destabilization of the amine surfactant by deprotonation, i.e., the amine losses its positive charge as the pH is raised by the application of the basic solution. Because of the destabilization brought about by aluminum sulfate, the emulsion breaks and sets earlier, resulting in faster drying and binder cohesion development and adhesion to aggregates and the underlying surface. Further, both the asphalt emulsion viscosity and the sweep performance increases due to the faster drying of the emulsion brought about by the asphalt droplet destabilization. Increased drying times of the asphalt emulsion can be confirmed by measuring the water loss in the sweep performance test. The sweep performance of the asphalt emulsion can be determined according to ASTM 7000.

Methods of using the asphalt formulations described herein are disclosed. The asphalt formulations can be applied to a surface to be treated, restored, or sealed. Prior to application of the asphalt formulation, the surface to be treated is usually cleaned to remove excess surface dirt, weeds, and contaminants by, for example, brushing the surface, blasting the surface with compressed air, or washing the surface. The asphalt formulations can be applied using any suitable method for applying a liquid to a porous surface, such as brushing, wiping and drawing, or spraying.

In some embodiments, the asphalt formulations, once applied, wet the surface thereby forming a layer on at least a portion and typically at least a substantial portion (e.g. more than 50%) of the surface. In some embodiments, when asphalt emulsions are applied to a surface, water loss occurs in the emulsion, primarily due to adsorption of the water. The water also delivers the asphalt and the cationic latex composition to the surface. In some embodiments, the asphalt emulsion penetrates and adheres to the surface it is applied to, cures in a reasonably rapid time, and provides a water-tight and air-tight barrier on the surface. The asphalt emulsion layer also promotes adhesion between the older surface and the later applied surface treatment layer. It is desirable for the asphalt formulations to be easily applied and have an adequate shelf life.

An aggregate can be blended into the asphalt formulation before application to a surface. In some embodiments, the aggregate can be applied to the asphalt formulation after it is applied to a surface. For example, sand can be applied to the asphalt formulation after it is applied to a surface, for example, if the formulation is to be used as a tack coat, to reduce the tackiness of the surface. The asphalt formulation and optionally the aggregate can be compacted after application to the surface as would be understood by those of skill in the art.

The asphalt formulations can be applied for use in a pavement or paved surface. A pavement surface or a paved surface is a hard surface that can bear pedestrian or vehicular travel can include surfaces such as motorways/roads, parking lots, bridges/overpasses, runways, driveways, vehicular paths, running paths, walkways, and the like. The asphalt formulations can be applied directly to an existing paved surface or can be applied to an unpaved surface. In some embodiments, the asphalt formulations can be applied to an existing paved layer as a tie layer, and a new layer comprising asphalt such as a hot mix layer is applied to the tie layer. The asphalt formulations can be applied to a surface “cold,” i.e., at a temperature below 40° C., or can be applied to at an elevated temperature, for example, from 50° C. to 120° C., from 55° C. to 100° C., or from 60° C. to 80° C.

In some embodiments, the asphalt formulations can be used as a tack coat or coating. The tack coat is a very light spray application of diluted asphalt emulsion that can be used to promote a bond between an existing surface and the new asphalt application. The tack coat acts to provide a degree of adhesion or bonding between asphalt layers, and in some instances, can fuse the layers together. The tack coat also acts to reduce slippage and sliding of the layers relative to other layers in the pavement structure during use or due to wear and weathering of the pavement structure. In some embodiments, the asphalt formulations can be applied to an existing paved layer (such as a hot-mix layer) as a tack coat, and a new layer comprising asphalt such as a hot-mix layer can be applied to the tack coat. As would be understood by those skilled in the art, the tack coat typically does not include aggregate, although sand may be applied to the tack coat after application as mentioned herein.

As described herein, the asphalt formulations cure/dry quickly. For example, where the asphalt formulations are used as a tack coating, the coating cures quickly such that a pavement layer may be applied to the coating, hours to days after the emulsion is applied to the substrate. In some embodiments, the applied composition can cure in 15 minutes to 45 minutes, and may cure as rapidly as less than 1 minute to 15 minutes after the composition is applied to the exposed surface. The cure rate will depend on the application rate, the dilution ratios used, the base course conditions, the weather, and other similar considerations. If the prepared pavement surface or base course contains excess moisture, the curing time of the asphalt formulations may be increased.

In some embodiments, the asphalt formulations can also be used as a fog seal. A fog seal is a surface treatment that applies a light application of the composition to an existing paved surface such as a parking lot to provide an enriched pavement surface that looks fresh and black. In some embodiments, the fog seal would include a filler such as carbon black to blacken the composition. As would be understood by those skilled in the art, the fog seal might not include aggregate. The fog seal compositions, like the bond coat compositions, have also been shown to be to be low-tracking or “trackless” coatings.

In some embodiments, the asphalt formulations can be used as a chip seal composition. Chip seals are the most common surface treatment for low-volume roads. The chip seal composition can be applied to a surface followed by the application of aggregate. In some embodiments, the asphalt formulations can be used in a microsurfacing application. Microsurfacing is designed for quick traffic return with the capacity of handling high traffic volume roadways. For the microsurfacing composition, aggregate can be mixed in with the cationic asphalt composition before application to a surface.

In some embodiments, the asphalt formulations can be used in paints, coatings, paper coating or binding compositions, carpet compositions (e.g., carpet backing), foams, or adhesives.

By way of non-limiting illustration, examples of certain embodiments of the present disclosure are given below.

### EXAMPLES

The following examples are put forth so as to provide those of ordinary skill in the art with a complete disclosure and description of how the compositions and/or methods claimed herein are made and evaluated, and are intended to be purely exemplary and are not intended to limit the scope of the disclosure. Unless indicated otherwise, parts are parts by weight, temperature is in ° C. or is at ambient temperature, and pressure is at or near atmospheric.

### Example 1

Preparation of Asphalt Emulsions

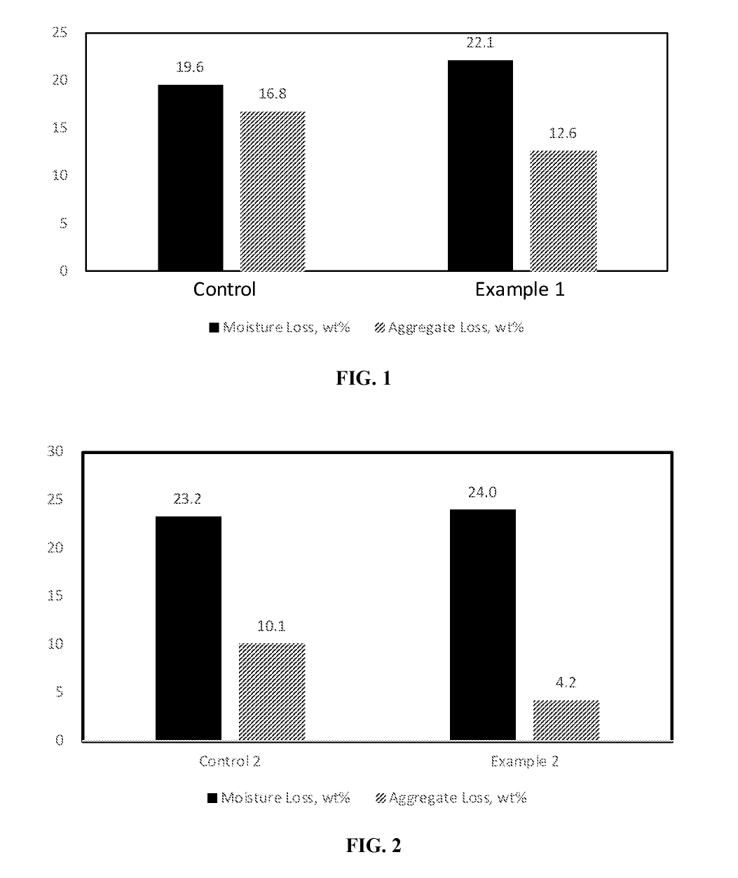

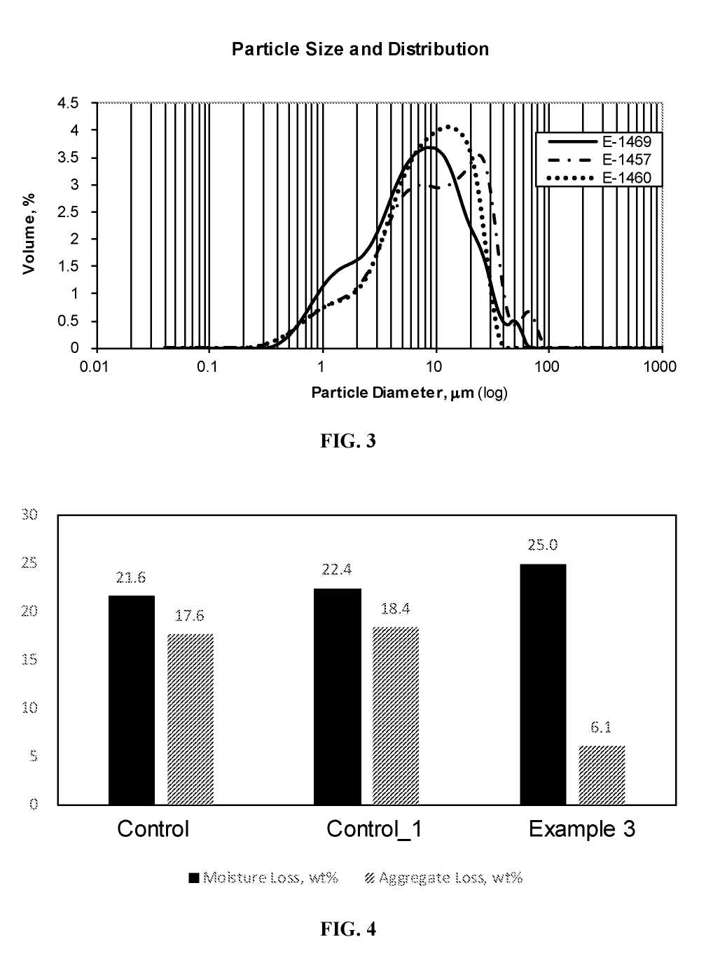

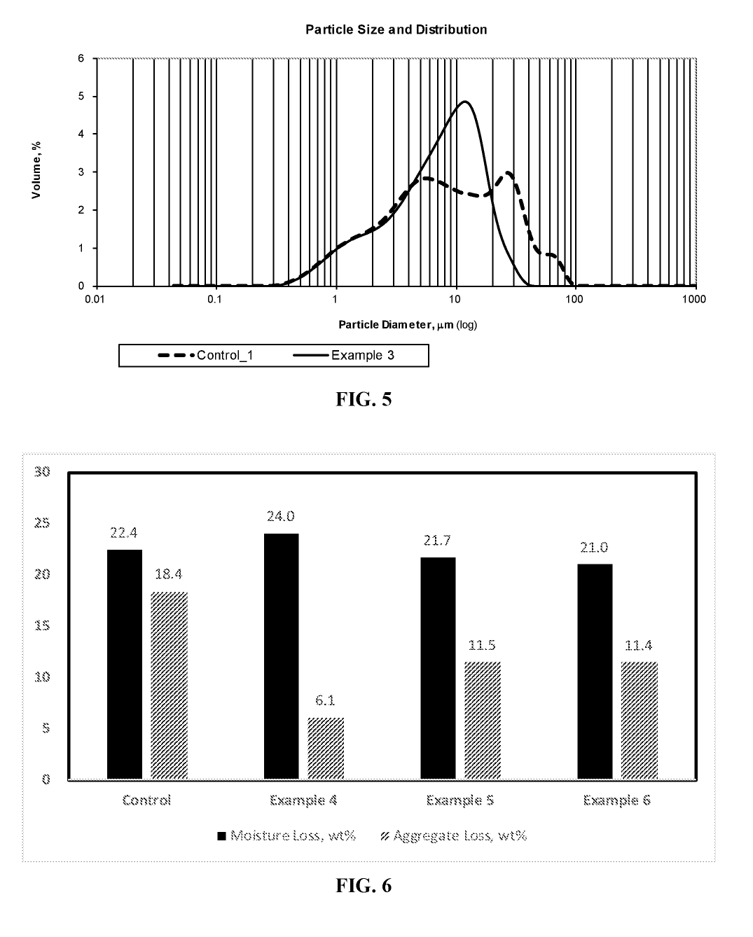

A cationic styrene-butadiene latex composition was prepared by mixing polyphosphoric acid, a sulfur curing agent, and accelerator with a styrene-butadiene latex. Optionally, the styrene-butadiene latex was ‘flipped’ with hydrochloric acid or phosphoric acid, prior to addition of polyphosphoric acid. In some examples, aluminum sulfate was added to the cationic latex composition. The cationic latex composition and molten Axeon 58-28 asphalt were pumped into a colloid mill where high shear mixing produces an asphalt emulsion having asphalt droplets dispersed in the water. The polymer amounts are based on asphalt solids and the other components are based on latex polymer solids. The amounts of each ingredient are given in Tables 1 and 2. The viscosity, particle size, softening point, and penetration at 25° C. of the asphalt emulsions were determined. The standard deviations were calculated. The results are summarized in Tables 1-3. Graphs showing the moisture loss and aggregate loss as well as the particle size distribution of the asphalt emulsions are shown in FIGS. 1-7.

TABLE 1
Properties of particles in asphalt emulsions.

| | Sample | | | |
|---|---|---|---|---|
| | Control | Control 2 | Ex 1 | Ex 2 |
| Polymer (%) | 3 | 3 | 3 | 3 |
| HCl (%) | 0.38 | 0.38 | 0.38 | — |
| H₃PO₄ (%) | | — | — | 0.84 |
| PPA (%) | — | — | 0.5 | 1.5 |
| Asphalt (% total | 69 | 69 | 69 | 69 |
| solids) | | | | |
| Viscosity, cp (spd | 145 | 350 | 265 | 255 |
| 3/rpm 20) | | | | |
| Mean Particle Size | 20.9 | 14.68 | 12.31 | 10.26 |
| (μm) | | | | |
| Median Particle | 9.04 | 9.95 | 7.48 | 7.18 |
| Size (μm) | | | | |
| Particle Size | 23.9 | 14.4 | 12.56 | 10.02 |
| Standard Deviation | | | | |
| (μm) | | | | |

TABLE 2
Properties of particles in asphalt emulsions.

| Sample | Control | Control_1 | Ex 3 | Ex 4 | Ex 5 | Ex 6 |
|---|---|---|---|---|---|---|
| Polymer (%) | 3 | 3 | 3 | 3 | 3 | 3 |
| HCl (%) | — | — | — | — | — | 0.38 |
| H₃PO₄ (%) | — | — | 0.84 | — | — | — |
| Al₂SO₄ (%) | — | — | 1.5 | — | — | |
| PPA (%) | — | — | 1.5 | 1.5, pH 3 | to pH 5 to 5.6 | 1.5, pH 5-5.6 |
| Asphalt (% total | | 70.11 | 70.8 | 69.03 | 70.94 | 71 |
| solids) | | | | | | |
| Viscosity, cp (spd | | 105 | 325 | 345 | 160 | 100 |
| 3/rpm 20) | | | | | | |
| Mean Particle | | 14.94 | 9.22 | 9.37 | 12.93 | 11.17 |
| Size (μm) | | | | | | |
| Median Particle | | 8.5 | 7.91 | 7.99 | 9.58 | 7.37 |
| Size (μm) | | | | | | |
| Particle Size | | 16.18 | 6.83 | 6.86 | 11.65 | 11.9 |
| Standard | | | | | | |
| Deviation (μm) | | | | | | |

Example 3 includes aluminum sulfate post-added to a phosphoric-acid-flipped cationic latex composition that contains 1.5% polyphosphoric acid. Example 4 includes a cationic latex made by the addition of 1.5% polyphosphoric acid but no other acid resulting in a latex pH of 3. Example 5 includes a cationic latex made by the addition of polyphosphoric acid but no other acid to lower the pH of the latex from higher than 10 to 5-5.6. Example 6 includes polyphosphoric acid post-added to the hydrochloric acid-flipped cationic latex and the pH adjusted with 25% KOH to 5-5.6.

As shown in Table 1, there was a decrease in the particle size and the particle size distribution was narrower for the asphalt emulsions modified with the cationic latex composition compared to the asphalt emulsions that were not modified with the cationic latex composition (control).

TABLE 3
Properties of asphalt emulsions.

| Residue # | Control | Example 7 | Example 8 | Example 4 | Example 3 |
|---|---|---|---|---|---|
| ER 10C SG | 68.75% | 63.75% | 67.50% | 76.25% | 73.75% |
| 20 cm 5mn, % | | | | | |
| ER 10C SG | 71.25% | 66.25% | 70.00% | 78.75% | 73.75% |
| 20 cm 5mn, % | | | | | |
| ER 10C SG | 71.25% | 67.50% | 67.50% | 78.75% | 72.50% |
| 20 cm 5mn, % | | | | | |
| Avg | 70% | 66% | 68% | 78% | 73% |
| Softening | 65.4 | 74.1 | 80.1 | 69.4 | 67.2 |
| Point, ° C. | | | | | |
| Softening | 65.7 | 70.2 | 81.8 | 70.1 | 73.4 |
| Point, ° C. | | | | | |
| Avg | 65.6 | 72.2 | 81 | 69.8 | 70.3 |
| Pen 25° C. | 81 | 72 | 70 | 66 | 75 |
| Pen 25° C. | 75 | 72 | 74 | 69 | 75 |
| Pen 25° C. | 81 | 74 | 73 | 74 | 73 |
| Avg | 79 | 73 | 72 | 70 | 74 |

Preparation of Hot Mix Asphalt Compositions

SHRP Binder Testing of the Latex-Modified Asphalt

Asphalt was preheated to about 160° C. for at least two hours and then 650 grams of the heated asphalt was poured into a metallic can. The asphalt-containing can was heated to about 170° C. using a heating mantle. A blade was inserted at an angle at approximately 20° in the middle of the can to provide optimum mixing. A styrene butadiene (SB) latex composition comprising polyphosphoric acid, a sulfur curing agent, and an accelerator was added slowly to the hot asphalt with mixing at 300-325 rpm. Unless otherwise specified, the amount of latex polymer solids added to the asphalt was 3 wt % based on the total solids content of the latex polymer and asphalt. After each addition, time was allowed for most of the bubbling to cease and then the mixer speed was increased to approximately 400-700 rpm to blend the resulting mixture. After latex addition, the mixing was continued for two additional hours to achieve an equilibrated asphalt polymer mixture. Samples of the polymer-modified asphalts were taken for viscosity measurement or poured into molds for any desired testing.

The Strategic Highway Research Program (SHRP) evaluation of latex polymer-modified asphalts was carried out according to the ASTM D7175 or AASHTO T315 procedure on the original latex modified asphalt and on the latex modified asphalt following Rolling Thin-Film Oven (RTFO) exposure, and also on the RTFO conditioned latex modified asphalt that was conditioned in the Pressure Aging Vessel (PAV). The Dynamic Shear Rheometer (DSR) tests measure the dynamic shear modulus and stiffness of the latex polymer-modified asphalt. Testing of the original (unaged or fresh) latex modified asphalt and of the latex modified asphalt after RTFO exposure provided the High Temperature in the Performance Grade (PG) scale.

Viscosity of Latex-Modified Asphalt

The viscosities of the cationic latex modified asphalts prepared according to the methods described above were measured according to ASTM D4402 or AASHTO T316 (American Association of State Highway and Transportation Officials).

Elastic Recovery of Latex-Modified Asphalt

The elastic recoveries of the latex modified asphalt binders prepared according to the methods described above were measured using a ductilometer according to a modified ASTM D6084 Procedure B testing protocol.

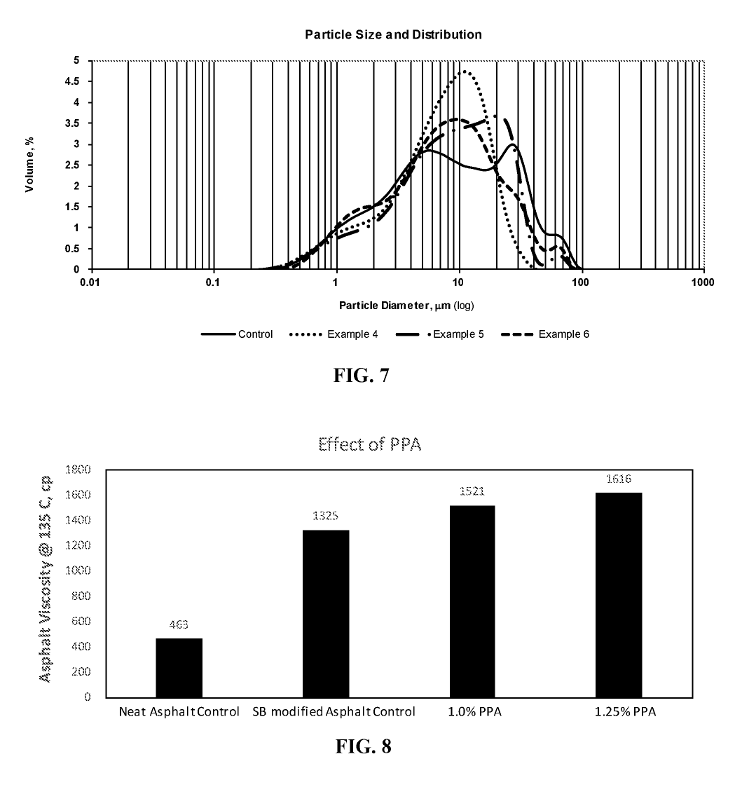

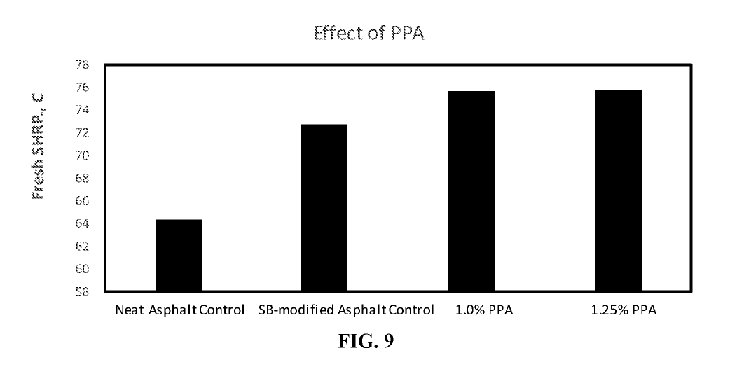

Graphs showing the effect of polyphosphoric acid on the viscosity and Fresh SHRP of carboxylated styrene butadiene modified hot mix asphalt compositions are shown in FIGS. 8 and 9.

TABLE 4
Properties of Polymer-modified Western States 64-22 Hot-mix
Asphalt Emulsions.

| | Sample # | | | |
|---|---|---|---|---|
| | Neat | | | |
| | Asphalt | Example 9 | Example 10 | Example 11 |
| Base Asphalt | 64-22 | 64-22 | 64-22 | 64-22 |
| Latex | | carboxylated | carboxylated | carboxylated |
| | | SB latex | SB latex | SB latex |
| | | (0% PPA) | (0.25% | (0.5% PPA) |
| | | | PPA) | |
| ER 10C SG | NA | 68.75% | 66.25% | 67.50% |
| 20 cm 5mn, % | | | | |
| ER 10C SG | NA | 70% | 66.25% | 68% |
| 20 cm 5mn, % | | | | |
| Fresh SHRP | 64.4 | 71.3 | 71.8 | 73.6 |
| High T | | | | |
| RTFO SHRP | 65.3 | 71.9 | 71.7 | 74.3 |
| High T | | | | |
| Viscosity | 491 | 1216 | 1179 | 1312 |
| @135° C., cp | | | | |

As shown in Table 4, the asphalt compositions containing polyphosphoric acid modified carboxylated SB latex exhibited higher high temperature fresh SHRP (original) sample than for asphalt compositions without polyphosphoric acid modified carboxylated SB latex. The change in high temperature fresh SHRP occurred without a significant increase in asphalt viscosity.

TABLE 5
Properties of Polymer-modified Nustar 64-22 Hot-mix Asphalt

Sample #

| | | Example 12 |
|---|---|---|
| | Neat Asphalt | (3% Latex Polymer) |
| Base Asphalt | 64-22 | 64-22 |
| Latex | | Non-carboxylated |
| | | SB latex |
| | | (2% PPA) |
| Fresh SHRP | 69.2 | 77.3 |
| High T | | |
| RTFO SHRP | 69.3 | 76.4 |
| High T | | |
| Viscosity | 559 | 1854 |
| @135° C., cp | | |

As shown in Table 5, the asphalt compositions containing polyphosphoric acid modified non-carboxylated SB latex raised the asphalt performance grade from 64° C. to 76° C., a 2 PG bump.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

1. A method of making a polymer-modified asphalt, comprising:
contacting asphalt with an aqueous latex dispersion comprising a polymer,
wherein the latex dispersion comprises polyphosphoric acid.

2. The method of claim 1, wherein the polyphosphoric acid includes a compound represented by the formula, Hₙ₊₂PₙO₃ₙ₊₁, wherein n is an integer from 2 to 30.

3. The method of claim 1, wherein the polyphosphoric acid is present in an amount of from 0.05 wt % to 15 wt %, based on the weight of the latex dispersion.

4. The method of claim 1, wherein the polymer is selected from styrene-butadiene copolymers, polychloroprene, styrene-butadiene-styrene block copolymers, ethylene vinyl acetate copolymers, styrene acrylic copolymers, pure acrylic polymers, vinyl acrylic copolymers, and combinations thereof.

5. The method of claim 4, wherein the dispersion has a pH of 7 or less.

6. (canceled)

7. The method of claim 1, wherein the latex dispersion comprises an additional acid selected from phosphoric acid, hydrochloric acid, sulfuric acid, citric acid, tartaric acid, and combinations thereof.

8. (canceled)

9. (canceled)

10. (canceled)

11. The method of claim 1, wherein the latex dispersion further comprises aluminum sulfate.

12. The method of claim 1, wherein the asphalt is further contacted with a sulfur curing agent.

13. (canceled)

14. (canceled)

15. (canceled)

16. (canceled)

17. (canceled)

18. The method of claim 1, wherein the latex dispersion is a cationic latex dispersion.

19. An aqueous, cationic latex dispersion comprising,
a polymer selected from styrene-butadiene copolymers, polychloroprene, styrene-butadiene-styrene block copolymers, ethylene vinyl acetate copolymers, styrene acrylic copolymers, pure acrylic polymers, vinyl acrylic copolymers, and combinations thereof; and
polyphosphoric acid.

20. The latex dispersion of claim 19, further comprising a sulfur curing agent.

21. An aqueous, latex dispersion comprising,
a polymer selected from styrene-butadiene copolymers, polychloroprene, styrene-butadiene-styrene block copolymers, ethylene vinyl acetate copolymers, styrene acrylic copolymers, pure acrylic polymers, vinyl acrylic copolymers, and combinations thereof; polyphosphoric acid; and
a sulfur curing agent.

22. The latex dispersion of claim 21, wherein the dispersion has a pH of 7 or less.

23. The latex dispersion of claim 22, wherein the polyphosphoric acid is present in an amount of 0.05 wt % to 15 wt %, based on the weight of the latex dispersion.

24. The latex dispersion of claim 21, wherein the latex dispersion further comprises an additional acid selected from phosphoric acid, hydrochloric acid, sulfuric acid, citric acid, tartaric acid, and combinations thereof.

25. (canceled)

26. (canceled)

27. The latex dispersion of claim 21, wherein the latex dispersion further comprises aluminum sulfate.

28. (canceled)

29. An asphalt emulsion comprising:
asphalt,
a polymer selected from styrene-butadiene copolymers, polychloroprene, styrene-butadiene-styrene block copolymers, ethylene vinyl acetate copolymers, styrene acrylic copolymers, pure acrylic polymers, vinyl acrylic copolymers, and combinations thereof,
a cationic surfactant,
polyphosphoric acid,
a sulfur curing agent, and
water.

30. (canceled)

31. The asphalt emulsion of claim 29, wherein the polymer is present in an amount of from 0.05 wt % to 10 wt %, based on the weight of the asphalt emulsion.

32. (canceled)

33. The asphalt emulsion of claim 29, wherein the asphalt emulsion does not include an organic phosphorous-containing compound.

34. The asphalt emulsion of claim 29, further comprising aluminum sulfate.

35. (canceled)

36. The asphalt emulsion of claim 29, wherein when the asphalt emulsion comprises an asphalt solids content of 65 wt %, based on the weight of the asphalt emulsion, the asphalt emulsion has a viscosity of from 100 to 2500 cp at 60° C., as determined by a Brookfield viscometer, spindle #3 at 20 rpm.

37. (canceled)

38. A hot mix asphalt composition comprising,
asphalt,
a polymer latex,
polyphosphoric acid, and
a sulfur curing agent,
wherein the polymer latex has a pH of 7 or less.

39. The hot mix asphalt composition of claim 38, wherein the polymer latex comprises a polymer selected from styrene-butadiene copolymers, polychloroprene, styrene-butadiene-styrene block copolymers, ethylene vinyl acetate copolymers, styrene acrylic copolymers, pure acrylic polymers, vinyl acrylic copolymers, and combinations thereof.

40. (canceled)

41. (canceled)

42. The hot mix asphalt composition of claim 38, wherein the polymer latex is present in an amount of from 0.05 wt % to 10 wt %, based on the weight of the hot mix asphalt composition.

43. (canceled)

44. The hot mix asphalt composition of claim 38, further comprising aluminum sulfate.

45. (canceled)

46. The hot mix asphalt composition of claim 38, wherein when the hot mix asphalt comprises an asphalt solids content of at least 95 wt %, based on the weight of the asphalt emulsion, the hot mix asphalt has a viscosity of from 1000 to 3000 cp at 60° C., as determined by a Brookfield viscometer, spindle #3 at 20 rpm.

47. (canceled)

48. (canceled)

49. (canceled)
